(19) United States
(12) Patent Application Publication
(10) Pub. No.: US 2010/0286575 A1
(43) Pub. Date: Nov. 11, 2010

(54) PASSIVE EXERCISE EQUIPMENT USED IN STANDING POSITION

(76) Inventors: Kazuhiro Ochi, Osaka-shi (JP); Takao Gotou, Hirakata-shi (JP); Youichi Shinomiya, Ibaraki-shi (JP); Takahisa Ozawa, Katano-shi (JP)

Correspondence Address: Cheng Law Group, PLLC, 1100 17th Street, N.W., Suite 503, Washington, DC, 20036, US

(21) Appl. No.: 12/809,706

(22) PCT Filed: Dec. 25, 2008
(86) PCT No.: PCT/JP2008/073518

§ 371 Date: Jun. 21, 2010

(30) Foreign Application Priority Data
Dec. 28, 2007 (JP) 2007 341340

(51) Int. Cl. A61H 1/00

(52) U.S. Cl. 601/5

(57) ABSTRACT

Passive exercise equipment used in a standing position includes a left foot base and a right foot base on which left and right feet of a user in a standing position can be rested, respectively, and the left foot base and the right foot base moves on at least one plane surface through a drive unit. The left foot base, the right foot base and the drive unit are mounted on a housing. A range in which distance in a right and left direction between right and left ankle joints is smaller or larger than distance between right and left hip joints is included in moving ranges of the left foot base and the right foot base.

### TECHNICAL FIELD

The invention relates generally to passive exercise equipment used in standing position for moving, through a drive unit, right and left foot bases on which right and left feet of a user in standing position are rested respectively and thereby passively applying muscle stimulation to the user to induce the user's muscle activity.

### BACKGROUND ART

Prior art exercise equipment provides an easy way to get exercise indoors (e.g., see Japanese Patent Application Publication No. 2004-261256 (hereinafter referred to as a “first prior art”) and Japanese Patent Application Publication No. 2004-267724 (hereinafter referred to as a “second prior art”)). The exercise equipment has steppers on which user's soles can be rested and a drive unit for oscillating the steppers, and enables passive exercise. Each of the first and second prior arts provides monotone bending and stretching exercises for ankles to facilitate the flow of blood.

By the way, weakening of stamp force like aged persons predispose a person to fall, and accordingly it is desirable to strengthen muscle groups such as calves or the like. Each of the first and second prior arts is insufficient to reasonably and efficiently strengthen muscle groups for controlling stamp force while keeping balance.

### DISCLOSURE OF THE INVENTION

It is an object of the present invention to induce muscle activity in muscle groups outside and inside legs to build stamp force while keeping balance reasonably and efficiently.

Passive exercise equipment used in a standing position, of the present invention comprises a left foot base and a right foot base on which left and right feet of a user in a standing position can be rested, respectively; a drive unit for moving the left foot base and the right foot base on at least one plane surface; and a pedestal on which the left foot base, the right foot base and the drive unit are installed. In an aspect of the invention, the left foot base and the right, foot base are configured so that a range in which distance in a right and left direction between right and left ankle joints differs from distance between right and left hip joints is included in moving ranges of the left foot base and the right foot base.

In this configuration (hereinafter referred to as a “first configuration”), the range in which the distance in the right and left direction between the right and left ankle joints differs from the distance between the right and left hip joints is included in the moving ranges of the left foot base and the right foot base. Accordingly, it is possible to enhance muscle activity of the muscle groups of the buttocks. In addition, since the left foot base and the right foot base are moved on at least one plane surface, muscle groups of the legs are stretched and contracted. Thereby, it is possible to promote the provision of sugar for muscles and venous return to promise blood circulation promotion.

In an embodiment, the left foot base and the right foot base are configured so that a range in which the distance in the right and left direction between the right and left ankle joints is smaller than the distance between the right and left hip joints is included in the moving ranges of the left foot base and the right foot base. In this configuration, since the range in which the distance in the right and left direction between the right and left ankle joints is smaller than the distance between the right and left hip joints is included in the moving ranges of the left foot base and the right foot base, it is possible to enhance muscle activity of the muscle groups of the buttocks.

In an embodiment, the left foot base and the right foot base are configured so that a range in which the distance in the right and left direction between the right and left ankle joints is larger than the distance between the right and left hip joints is included in the moving ranges of the left foot base and the right foot base. In this configuration, since the range in which the distance in the right and left direction between the right and left ankle joints is larger than the distance between the right and left hip joints is included in the moving ranges of the left foot base and the right foot base, it is possible to enhance muscle activity of adductor muscles.

In an embodiment, the passive exercise equipment further comprises a range adjuster configured to adjust moving ranges in the right and left direction of the left foot base and the right foot base. In this configuration, it is possible to adjust moving ranges in the right and left direction of the left foot base and the right foot base through the range adjuster. Accordingly, it is possible to enhance muscle activity of the muscle groups of the buttocks by adjusting so as to include, in the moving ranges of the left foot base and the right foot base, the range in which the distance in the right and left direction between the right and left ankle joints is smaller than the distance between the right and left hip joints. It is also possible to enhance muscle activity of adductor muscles by adjusting so as to include, in the moving ranges of the left foot base and the right foot base, the range in which the distance in the right and left direction between the right and left ankle joints is larger than the distance between the right and left hip joints. That is, the regions of muscle activity to be strengthened can be adjusted.

Passive exercise equipment used in a standing position, of the present invention comprises a left foot base and a right foot base on which left and right feet of a user in a standing position can be rested, respectively; a drive unit for moving the left foot base and the right foot base on at least one plane surface; and a pedestal on which the left foot base, the right foot base and the drive unit are installed. In an aspect of the invention, the passive exercise equipment further comprises a range adjuster configured to adjust moving ranges in a right and left direction of the left foot base and the right foot base.

In this configuration (hereinafter referred to as a “second configuration”), it is possible to adjust moving ranges of the left foot base and the right foot base through the range adjuster. Accordingly, it is possible to enhance muscle activity of the muscle groups of the buttocks by adjusting so as to include, in the moving ranges of the left foot base and the right foot base, the range in which the distance in the right and left direction between the right and left ankle joints is smaller than the distance between the right and left hip joints. It is also possible to enhance muscle activity of adductor muscles by adjusting so as to include, in the moving ranges of the left foot base and the right foot base, the range in which the distance in the right and left direction between the right and left ankle joints is larger than the distance between the right, and left hip joints. That is, the regions of muscle activity to be strengthened can be adjusted. In addition, since the left foot base and the right foot base are moved on at least one plane surface, muscle groups of the legs are stretched and contracted. Thereby, it is possible to promote the provision of sugar for muscles and venous return to promise blood circulation promotion.

In the first configuration or the second configuration, passive exercise equipment may further comprises: an operation input part for inputting an attribution by which the distance between user's right and left hip joints can be calculated, as well as a region to be strengthened by exercise; and a range decision part configured to estimate the distance between the right and left hip joints based on the attribution input through the operation input part and also decide the moving ranges of the left foot base and the right foot base based on the region input through the operation input part and the estimated distance between the hip joints. The range adjuster comprises a drive source and is configured to adjust the moving ranges of the left foot base and the right foot base in response to a command value. The range decision part is configured to supply the range adjuster with a decided moving range as the command value. In this configuration, the user enters the attribution such as the user's body height and a region mainly to be strengthened through the operation input part, and thereby the moving ranges of the left foot base and the right foot base based are decided. In addition, a command value in response to the decided moving ranges is supplied to the range adjuster comprising the drive source. Thereby, the moving ranges of the left foot base and the right foot base are automatically adjusted, and the trouble of adjustment of the moving ranges is saved. If an attribution as necessary information by which the distance between user's right and left hip joints can be calculated, as well as a region to be strengthened are input through the operation input part, the relationship between distance between hip joints and distance in the right and left direction between ankle joints in the moving ranges of the left foot base and the right foot base is defined.

In the first configuration or the second configuration, the drive unit may be configured to change each position in a front-back direction of the left foot base and the right foot base. In this configuration, the positions of the left foot base and the right foot base are changed in the front-back direction. Accordingly, the positions of the user's feet are moved back and forth like walking, thereby stimulating muscle groups for bending and stretching, namely rectus femoris muscles, vastus medialis muscles, vastus lateralis muscles, biceps femoris, tibialis anterior muscles, gastrocnemius muscles or the like.

In the first configuration or the second configuration, the drive unit may be configured to change each position in a right and left direction of the left foot base and the right foot base. In this configuration, since the positions of the left foot base and the right foot base are changed in the right and left direction, vastus lateralis muscle, adductor muscles and so on are stimulated.

In the first configuration or the second configuration, the drive unit is configured to change each position in a front-back direction and a right and left direction of the left foot base and the right foot base. In this configuration, since the positions of the left foot base and the right foot base are changed in the front-back direction and the right and left direction, various muscles of the legs are stimulated, and the provision of sugar for muscles and venous return are further promoted.

### BRIEF DESCRIPTION OF THE DRAWINGS

Preferred embodiments of the invention will now be described in further details. Other features and advantages of the present invention will become better understood with regard to the following detailed description and accompanying drawings where:

FIG. 1 is a schematic plane view of a first embodiment of the present invention;

FIG. 2 is an exploded perspective view of the first embodiment;

FIG. 3 is an explanatory diagram of operation of the first embodiment;

FIG. 4 is a system diagram of a drive unit used for the first embodiment;

FIG. 5 is a sectional view of an essential part in the first embodiment;

FIG. 6 is an explanatory diagram of operation of the essential part in the first embodiment;

FIG. 7 is a sectional view of the essential part in the first embodiment;

FIG. 8 illustrates advantageous effect of the first embodiment;

FIG. 9 illustrates advantageous effect of the first embodiment;

FIG. 10 is an exploded perspective view of an essential part in a second embodiment of the present invention;

FIG. 11 is a block diagram of a third embodiment of the present invention;

FIG. 12 is a perspective view of an essential part showing a constitutional example of the third embodiment;

FIG. 13 is a front view of the essential part showing the constitutional example of the third embodiment;

FIG. 14 is a back view of an essential part showing a constitutional example of the third embodiment; and

FIG. 15 shows a constitutional example of the third embodiment, FIG. 15A is a schematic back view, and FIG. 15B is a schematic front view.

### BEST MODE FOR CARRYING OUT THE INVENTION

### First Embodiment

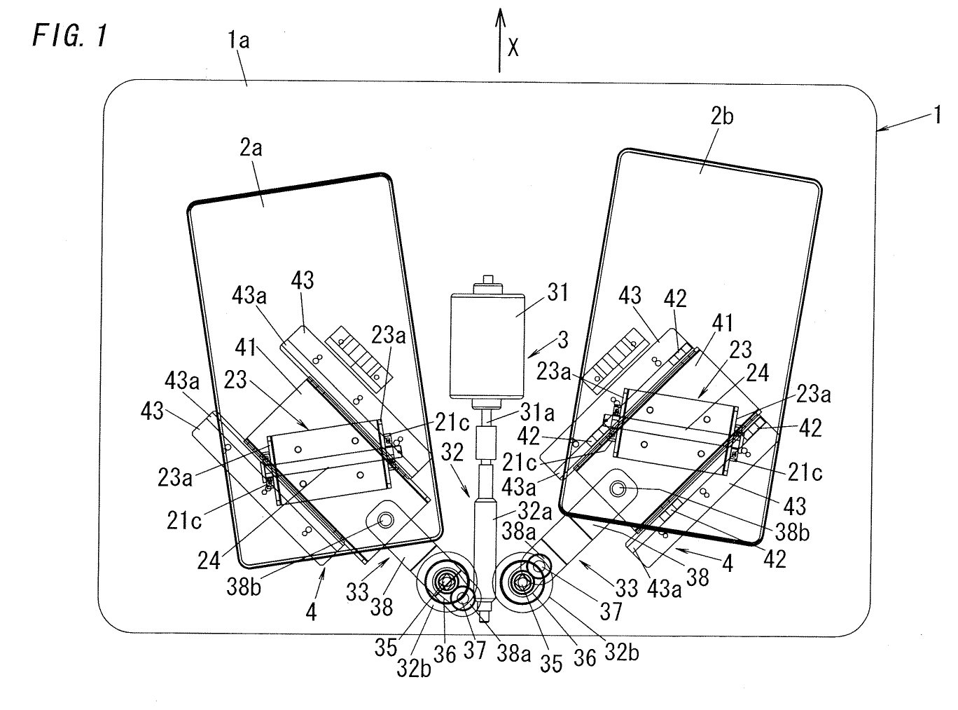

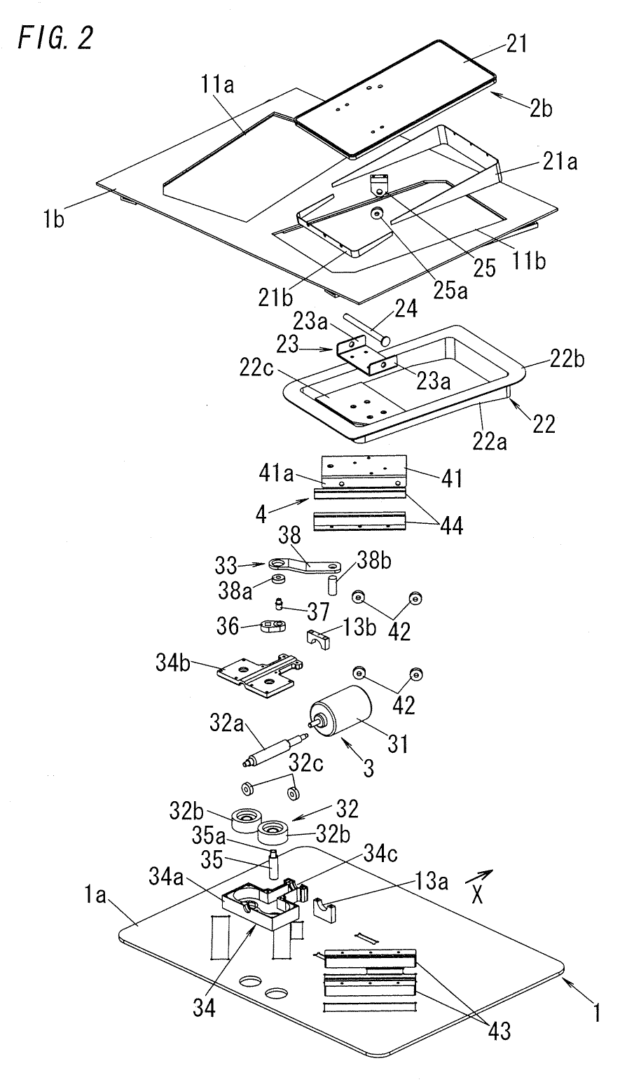

FIGS. 1 and 2 show a constitutional example as a basic configuration of the present invention. The embodiment illustrates a configuration put on the floor, but a configuration embedded in the floor can be adopted. There are options such as a configuration fixed in place and a movable configuration. The equipment to be described below can be used under condition that a user sits on a seat, but is intended to be used basically under condition that a user is in a standing position.

As shown in FIGS. 1 and 2, the embodiment has a base plate 1a as a pedestal put on the floor. The base plate 1a is in the shape of, but not limited to, a rectangle. For the purpose of brief explanation, when the base plate 1a is put on the floor, the top face of the base plate 1a is in parallel with the floor face. Therefore, the up-and-down of FIG. 1 corresponds to that in use.

An upper wall 1b is located above the base plate 1a, and the base plate 1a is coupled to the upper wall 1b, which constitute a housing 1. The housing 1 is in the shape of a rectangular parallelepiped as an option, but a hollow cylinder or polyangular or the like can be applied to an appearance configuration of the housing 1 if having a storage space inside. For the purpose of brief explanation, when the housing 1 is put on the floor, the top face of the housing 1 (the top face of the upper wall 1b) is intended to be parallel with the floor face. In the configuration embedded in the floor, a configuration only including parts except the upper wall 1b, as a framework can be applied to the housing 1.

The base plate 1a is provided thereon with a left foot base 2a and a right foot base 2b on which user's left and right feet are rested, respectively and a drive unit 3 for moving the left foot base 2a and the right foot base 2b. The direction of the arrow X in FIGS. 1 and 2 is hereinafter defined as a front direction. In other drawings, if the arrow X is depicted, the direction becomes a front direction.

The upper wall 1b is provided with two openings 11a and 11b pierced in a thickness direction, which expose the left foot base 2a and the right foot base 2b, respectively. Each of the openings 11a and 11b is rectangular. Each center line along length directions of the openings 11a and 11b intersects with the front-back direction of the housing 1, and the distance between the center lines at the anterior end side of the housing 1 is longer than that at the posterior end side. The angle between each length direction of the openings 11a and 11b and the front-back direction of the base plate 1a is arbitrarily set. For example, the angle is set in the range of 5-15 degrees. The angle with respect to the left opening 11a is a counterclockwise angle around the posterior end as the center, and the angle with respect to the right opening 11b is a clockwise angle around the posterior end as the center.

Slide grooves (not shown) are formed at both sides in each width direction of the openings 11a and 11b to open inward. Flanges 22b of footrest frames 22 are slidably inserted into the slide grooves. The left foot base 2a and the right foot base 2b are formed of the footrest frames 22, and footrest plates 21 on which user's feet can be rested. The footrest frames 22 each have body parts 22a like rectangular frames. Each flange 22b is formed all around its own body part 22a along one opening face (a top face) of the body part 22a. An attachment plate 22c is integrally formed at each inner bottom of the body parts 22a.

The length and width of the body parts 22a are smaller in size than the openings 11a and 11b, and the length and width of the flanges 22b are larger in size than the openings 11a and 11b. The distance between the bottoms of slide grooves 12 is larger than that between the edges of each flange 22b. Therefore, each footrest frame 22 can move in the range of the slide grooves 12 in the width direction, and also move in the length direction.

The footrest plates 21 are each rectangular shaped plates slightly smaller than the inner edges of the body parts 22a of the footrest frames 22, and each size is set so that the whole foot of users can be rested thereon. A material or shape for increasing a friction coefficient is applied to each top face of the footrest plates 21. Frame bodies 21a and 21b bent into the shape of a square bracket are integrally located at the periphery of each bottom face of the footrest plates 21. Each footrest plate 21 is integrally provided with a pair of bearings 21c spaced in its own width direction, which are situated on the bottom face of the footrest plate 21 and surrounded by frame bodies 21a and 21b

A bearing plate 23, which is opened upward and in the shape of a square bracket in cross section, is fixed on each top face of the attachment plates 22c of the footrest frames 22. Bearings 21c located in each footrest plate 21 touch the outer faces of the leg pieces 23a of a bearing plate 23. A shank 24 penetrating through the leg pieces 23a and the bearings 21c is further provided. Therefore, the shanks 24 are each arranged along the width direction of the footrest plates 21, and the footrest plates 21 can turn around the shanks 24 so that their own front and back parts in length directions can be moved up and down with respect to the footrest frames 22. The frame bodies 21a and 21b are used for covering gaps between the undersurfaces of the footrest plates 21 and the footrest frames 22, when the footrest plates 21 turn with respect to the footrest frames 22.

Carriages 41, which are opened downward and in the shape of a square bracket in cross section, are attached to the undersurfaces of the attachment plates 22c in the footrest frames 22. Two wheels 42 are attached to each outer side of the leg pieces 41a of the carriages 41. Two rails 43 are fixed on the top face of the base plate 1a with respect to each of the left foot base 2a and the right foot base 2b, and the carriages 41 are put on the rails 43 so that the wheels 42 can turn in rail grooves 43a formed on the upper parts of the rails 43. Wheel separation preventing plates 44 are each fixed on the top faces of the rails 43, and are in contact with lateral faces of the wheels 42 so as to prevent, the wheels 42 from separating from the rail grooves 43a.

In the embodiment, the length directions of the rails 43 are each different from the length directions of the opening ha and 11b formed on the housing 1. The openings 11a and 11b are each situated so that the distance between their center lines in the length directions at the front side of the housing 1 becomes larger than that at the rear side. The length directions of the rails 43 are also different from the front-back direction of the housing 1.

The length directions of rails 43 are each larger in angle than those of the openings 11a and 11b with respect to the front-back direction of the housing 1. For example, if the angles of the length directions of the openings 11a and 11b are 30° each with respect to the front-back direction of the housing 1, the angles of the length directions of the rails 43 are each set to 45° or the like. When the feet are rested on the left foot base 2a and the right foot base 2b, the center lines of the feet are agreed with the length directions of the openings 11a and 11b. In this condition, the left foot base 2a and the right foot base 2b are moved along the rails 43 and thereby the length directions of the rails 43 are set to the directions that shear force does not act on the knees even if the feet positions are changed.

In the configuration described above, the left foot base 2a and the right foot base 2b can reciprocate along the length directions of the rails 43 which differ from the center lines of the length directions of the openings 11a and 11b. Therefore, the footrest plates 21 and the footrest frames 22 can move in the openings 11a and 11b in directions intersecting with the length directions. That is, the carriages 41, the wheels 42 and the wheel separation preventing plates 44 function as guide parts 4 for restricting the movement, paths of the left foot base 2a and the right foot base 2b.

As shown in FIG. 4, the drive unit 3 for moving the left foot base 2a and the right foot base 2b has: a drive source 31 for generating a drive force; a system separation part 32 configured to divide the drive force for two systems to transmit the divided drive forces to the left foot base 2a and the right foot base 2b; and reciprocation drivers 33 configured to reciprocate the carriages 41 along the rails 43 by using the drive forces.

The drive unit 3 is further explained in detail. A rotary motor (hereinafter referred to as a “motor”, to which the reference numeral 31 is assigned) is applied to the drive source 31. The system separation part 32 is coupled to the output axis 31a of the motor 31.

The system separation part 32 includes a worm (a first gear wheel) 32a coupled to the output axis 31a of the motor 31, and a pair of worm wheels (second wheel gears) 32b engaged with the worm 32a. The worm 32a and two worm wheels 32b are put in a gearbox 34 fixed on the base 1a. The gearbox 34 is formed of a gear case 34a baying an upper opening, and a lid plate 34b attached to close, the opening of the gear case 34a. A pair of bearings 32c, which supports both ends in the length direction of the worm 32a, are attached between the gear case 34a and the lid plate 34b.

Rotary shafts 35 supported by the gear ease 34a and the lid plate 34b are inserted into the worm wheels 32b, and the worm wheels 32b are combined with the rotary shafts 35 so that the rotary shafts 35 can rotate in response to the rotation of the worm wheels 32b. A joint part 35a, of which cross section is in the shape of a non-circle (a rectangle in the graphical example), is formed on each top edge of the rotary shafts 35.

The motor 31 is mounted on a support part 34c provided for the gear case 34a and a support plate 13a fixed on the base plate 1a, and is fixed to the base plate 1a through the lid plate 34b attached to cover the gear case 34a and a presser plate 13b coupled to the support. plate 13a.

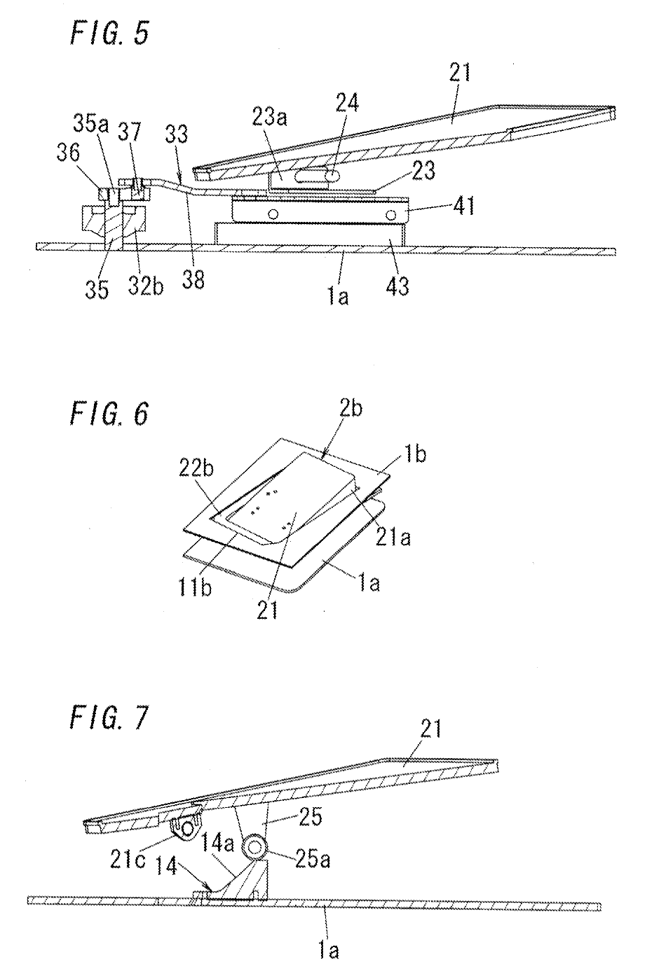

As shown in FIG. 5, each reciprocation driver 33 includes a crank plate 36 of which one end is coupled to the joint part 35a of a rotary shaft 35, and a crank rod 38 coupled to the crank plate 36 through a crankshaft 37. One end of the crankshaft 37 is fixed to the crank plate 36, while the other is held by a bearing 38a coupled to one end of the crank rod 38. That is the one end of the crank rod 38 is turnably connected to the crank plate 36. The other end of the crank rod 38 is coupled to a carriage 41 through a shaft 38b so that the other end of the crank rod 38 can turn with respect to the carriage 41.

Thus, the crank rod 38 functions as a conversion mechanism for converting rotative force of the worm wheel 32b into reciprocating motion of the carriage 41. Each of the worm wheels 32b is provided with a crank rod 38, and each of the left foot base 2a and the right foot base 2b is provided with a carriage 41. Accordingly, the crank rods 38 function as a conversion mechanism for converting rotative force of the worm wheels 32b into reciprocating motion of the left foot base 2a and the right foot base 2b, respectively.

Since the movement paths of the carriages 41 are restricted with the wheels 42 and the rails 43, the carriages 41 can reciprocate along the length directions of the rails 43 in response to rotation of the worm wheels 32b. That is, the rotation of the motor 31 is transmitted to the crank plates 36 through the worm 32a and the worm wheels 32b, and the carriages 41 reciprocate in straight lines along the rails 43 through the crank rods 38 coupled to the crank plates 36. As a result, the footrest frames 22 joined to the carriages 41 reciprocate along the rails 43. That is, the left foot base 2a and the right foot base 2b reciprocate in the length directions of the rails 43.

In the embodiment, a drive force is divided for two systems through the worm 32a and the pair of worm wheels 32b, and the drive forces for the two systems are each used for the left foot base 2a and the right foot base 2b. Accordingly, the left foot base 2a and the right foot base 2b are related and driven by the drive unit 3. The worm wheels 32b are engaged with the worm 32a so that the difference in the engaged positions becomes 180°. Therefore, when the left foot base 2a exists at the posterior end of its moving range, the right foot base 2b exists at the anterior end of its moving range. The posterior end in the moving range of the left foot base 2a is the right end in the moving range of the left foot base 2a, and the anterior end in the moving range of the right foot base 2b is the right end in the moving range of the right foot base 2b. Accordingly, in the right and left direction, the left foot base 2a and the right foot base 2b move in the same direction.

As is clear from the aforementioned configuration, the phase difference in movement of the left foot base 2a and the right foot base 2b can be arbitrarily set based on engagement positions between the worm 32a and the worm wheels 32b. When a user stands on the left foot base 2a and the right foot base 2b in a standing position, if the phase difference is 180° like the embodiment, the user's barycentric movement in the front-back direction gets less and accordingly it is available even if the user declines in balancing function. On the other hand, unless the phase difference is given, the user's barycentric movement in the front-back direction occurs, and accordingly it is useful for muscle group exercise of lower back or the like for keeping balancing function in addition to legs' muscle group exercise.

By the way, the footrest plates 21 provided for the left foot base 2a and the right foot base 2b can turn around the shanks 24 with respect to the footrest frames 22. Therefore, as shown in FIG. 6, it is possible to change a height position of the anterior end and the posterior end of the footrest plate 21. That is, changing height positions of toe and heel of foot rested on the footrest plate 21 enables plantarflexion and dorsiflexion of ankle joints.

Turning of the footrest plates 21 around the shanks 24 is interlocked with reciprocating motion along the rails 43. For this reason, as shown in FIG. 7, the base plate 1a is formed with a guide face 14 of which at least a part has an inclined face 14a along each movement path of the footrest plates 21. A tracing projection 25 is located on the undersurface of the footrest plate 21 and is in contact with the guide face 14. In the graphical example, the inclined face 14a is formed over the entire length of the guide face 14 and inclines at a constant angle with respect to the top face of the base plate 1a. However, not limited to this, at least a part of each guide face 14 may include an inclined face 14a. In the embodiment, rollers 25a rolling on the guide faces 14 are each located on the tips of the tracing projections 25. However, a material or a shape for reducing a frictional coefficient with respect to each guide face 14 may be selected for a tip of each tracing projection 25.

Thus, the tracing projections 25 touching the guide faces 14 are provided, and thereby in response to rotation of the motor 1, the left foot base 2a and the right foot base 2b reciprocate while the tracing projections 25 are in contact with the inclined faces 14a of the guide faces 14. At this time, the footrest plates 21 turn around the shanks 24, and the angles of the footrest plates 21 are changed with respect to the base plate 1a. Consequently, plantarflexion and dorsiflexion of ankle joints are performed.

By the way, when the equipment is used in a standing position, the left foot base 2a and the right foot base 2b are suspended at a default position. In the default position, a user rests the left and right feet on the left foot base 2a and the right foot base 2b, respectively to stand on the left foot base 2a and the right foot base 2b, and then activates the drive unit 3. The left foot base 2a and the right foot base 2b are arranged so that their length directions Dx make, for example, approximately a 9° angle each with the front-back direction (the direction of the arrow X). When standing on the left foot base 2a and the right foot base 2b, the user can stand in a natural standing position without contortion of the user's legs.

In the default position, the left foot base 2a and the right foot base 2b are situated at the same position in the front-back position. That is, in the default position, the left foot base 2a and the right foot base 2b are arranged on the straight line in the right and left direction. Therefore, in the default position, when the user stands on the left foot base 2a and the right foot base 2b, the straight line downward from the user's barycenter passes about the center of the left foot base 2a and the right foot base 2b.

As is clear from the aforementioned configuration, when the drive unit 3 is activated, the positions of the left foot base 2a and the right foot base 2b are changed in the front-back direction, and also changed in the right, and left direction in response to the position change in the front-back direction. In this instance, the left foot base 2a and the right foot base 2b reciprocate on straight lines along the rails 43, and move in different directions from the front-back directions of the feet. For example, they move in the directions which make 45° angle each with respect to the front-back direction of the housing 1.

In addition, the left foot base 2a and the right foot base 2b reciprocate along the rails 43, while at the same time the footrest plates 21 turn around the shanks 24. When the footrest plates 21 move forward, the tracing projections 25 ascend the inclined faces 14a of the guide faces 14. Accordingly, the ankle joints become dorsiflexion at the anterior ends of the left foot base 2a and the right foot base 2b, and also become plantarflexion at the posterior ends of the left foot base 2a and the right foot base 2b. The positions of the shanks 24 are set in the vicinity of heels of soles, and the angles of the plantarflexion and the dorsiflexion are set to approximately 10° each with respect to the top face of the base plate 1a as a reference level.

The relationship of plantarflexion and dorsiflexion with anteroposterior positions of the left foot base 2a and the right foot base 2b may be the reverse of the example above. The angle of the plantarflexion with respect to the reference level may be different from that of the dorsiflexion. The operations can be easily realized by forming each guide face 14 into a suitable shape.

As referred to above, when one of the left foot base 2a and the right foot base 2b is moved at anterior end, the other is moved at posterior end. In addition, when the one is moved in a left direction, the other is moved in a right direction. Thereby, the body trunk of a user is twisted, and stimulus can be applied to the user's bowel. However, because a user can freely move the upper body, the user may move the body so that the body trunk is not twisted.

Therefore, a balustrade may be provided so that a user can hold the balustrade in use. Thereby the user's upper body can be held. The balustrade may be integrally formed on the housing 1, or may be located at the building side in a point of use of the equipment. If the balustrade is provided, a user can support the body with the balustrade, and accordingly a user, even having a decline in balancing function, can easily use the equipment. The equipment is also used fundamentally in a standing position, but may be used in a sitting position by providing a seat when there is a difficulty in a standing position, for use such as rehabilitation or the like.

In the configuration above, the left, foot base 2a and the right foot base 2b move in the directions away from the body trunk in the right and left direction when moving from the posterior ends to the anterior ends of the moving ranges. Therefore, when the left foot base 2a and the right foot base 2b are both moved to the posterior ends of the moving ranges, the distance in the right and left direction between representative points becomes smaller than that when the bases 2a and 2b are both moved to the anterior ends of the moving ranges. The representative points are arbitrarily defined with reference to the left foot base 2a and the right foot base 2b. The movement path may be a straight line path as described later, or may be a path such as a curve line or meandering path. In addition, the straight line path may include different paths between anterior movement and posterior movement.

In those operation, the overall movement locus of the left foot base 2a and the right foot base 2b is in the shape of a V which opens forward. On the contrary, the movement locus may be in the shape of an inverted V by causing the distance in the right and left direction at the posterior ends to be wider than that at the anterior ends. The distance between the representative points at the anterior ends may be the same as that at the posterior ends (the easiest operation is the operation only in the front-back direction). The left end position and the right end position in the movement locus may be the same in the front-back position (the easiest operation is the operation only in the right and left direction).

In addition, as referred to above, the left foot base 2a and the right foot base 2b may turn around the shanks, respectively. For example, axes in right and left (width) directions of feet (as discussed previously), axes in front-back (length) directions of feet, axes in vertical directions of feet may be used individually or in combination, and thereby rotation around the axes are obtained. The rotation around the axes may be interlocked with movement of the left foot base 2a and the right foot base 2b along the upper wall 1b, or may be kept to a constant rotation angle irrespective of movement of the left foot base 2a and the right foot base 2b in use. Each of the axes may be formed of one shaft, or a plurality of axes may be formed of one member such as a ball joint or the like.

Turning around axes in feet's width directions changes the position relation between toes and heels in vertical directions, and accordingly ankle joints are turned. As a result, muscle stimulation to muscle groups of calves (gastrocnemius muscles or the like) is increased, and venous return from legs is stimulated in response to expansion and contraction of the muscle groups of calves. Thereby, whole body blood circulation are improved. In addition, user's muscle groups for maintaining balance in a front-back direction are stimulated by turning the ankle joints. Muscle activity of muscle groups of the lower back as well as the legs are also induced by a reflex in the nervous system for maintaining a posture for fall-prevention in a front-back direction in particular.

In use by a user having knock-knees or bow legs, by turning around the axes in the length directions of the feet, an inclination in a direction for correcting deformities of legs can be given to at least one of the left foot base 2a and the right foot base 2b. By changing the inclination angles, it is also possible to stimulate muscle activity in outer or inner side of the muscle groups of legs. Making a phase difference in movement of the left foot base 2a and the right foot base 2b enables twist exercise of a body trunk. (For example, if the phase difference is 180°, when one of them is at the anterior end, the other is at the posterior end.) In addition, by turning around axes in vertical directions, twist angle of a body trunk can be further increased, thereby promising improvement of visceral functioning.

When turned around axes in width or length directions of feet, the left foot base 2a and the right foot base 2b can be each inclined at constant angles with respect to a horizontal plane. When accompanied by angle changes in use, the left foot base 2a and the right foot base 2b may each have constant angle offsets. At this moment, the offsets mean biasing the angles with respect to the horizontal plane. When accompanied by the angle changes, the offsets mean biasing the angles at center positions of the angle changes with respect to the horizontal plane.

If constant inclination angles are set around axes in length directions of the user's feet, it is possible to correct deformities of the legs such as knock-knees or bow legs. If constant inclination angles are set around axes in width directions of the feet, it is possible to strengthen gastrocnemius muscles for controlling weight balance acting on the toes and knees.

When constant angle offsets are set around axes in the feet's width directions in use, a time period in which the heels are put below the toes is lengthened, thereby extending a time period which gastrocnemius muscles are stretched to enhance a stretch effect. That is, by stretching the muscle groups, it is possible to promote the elimination of waste products or to spread ankle joints' motion ranges. The force for totally tilting a user's body trunk back also acts on the user, thereby inducing muscle activity of muscle groups (such as low back, back and abdomen) for balance maintenance by a reflex in the nervous system. The offsets may be set by adjusting movable scopes of the left foot base 2a and the right foot base 2b, or by providing legs on the back side of the housing 1 to adjust each projection length of the legs from the housing 1. However, not limited to two foot bases such as the left foot base 2a and the right foot base 2b, one foot base may be provided.

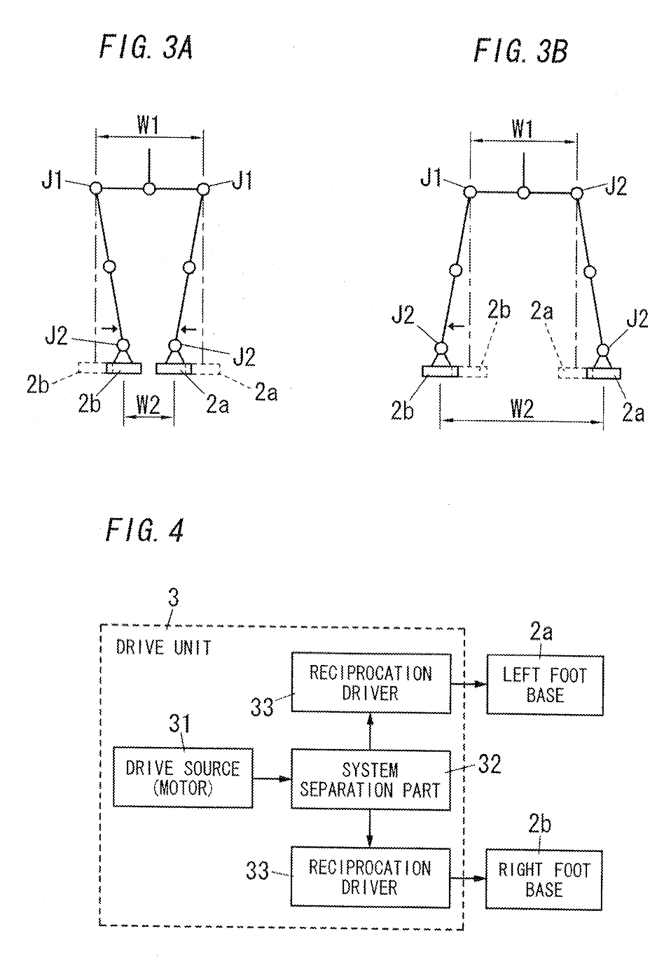

By the way, in the invention, as shown in FIG. 3A, a range (W1>W2) is included in the moving ranges of the left foot base 2a and the right foot base 2b. In the range (W1>W2), the distance “W2” between user's right and left ankle joints (J2) is smaller than the distance “W1” between the right and left hip joints (J1). The distance “W1” between the user's right, and left hip joints (J1) is affected by difference in body type among users. However, as the construction above, if the left foot base 2a and the right foot base 2b move right and left while moving back and forth, it is possible to provide a time period in which the distance “W2” is smaller than the distance “W1” irrespective of difference in body type among individuals while the left foot base 2a and the right foot base 2b move.

As shown in FIG. 3B, the operation, in which a range (W1<W2) is included in the moving ranges of the left foot base 2a and the right foot base 2b, may be applied. In the range (W1<W2), the distance “W2” between user's right and left ankle joints (J2) is larger than the distance “W1” between the right and left hip joints (J1). In the construction above, it is possible to provide a time period in which the distance “W2” is larger than the distance “W1,” irrespective of difference in body type among individuals while the left foot base 2a and the right foot base 2b move.

In the operation that the range in which the distance “W2” between the right and left ankle joints (J2) is smaller than the distance “W1” between the right and left hip joints (J1) is included in the moving ranges of the left foot base 2a and the right foot base 2b, it is possible to enhance muscle activity of mainly buttocks. In the operation that the range in which the distance “W2” between the right, and left ankle joints (J2) is larger than the distance “W1” between the right and left hip joints (J1) is included in the moving ranges of the left foot base 2a and the right foot base 2b, it is possible to enhance muscle activity of mainly adductor muscles.

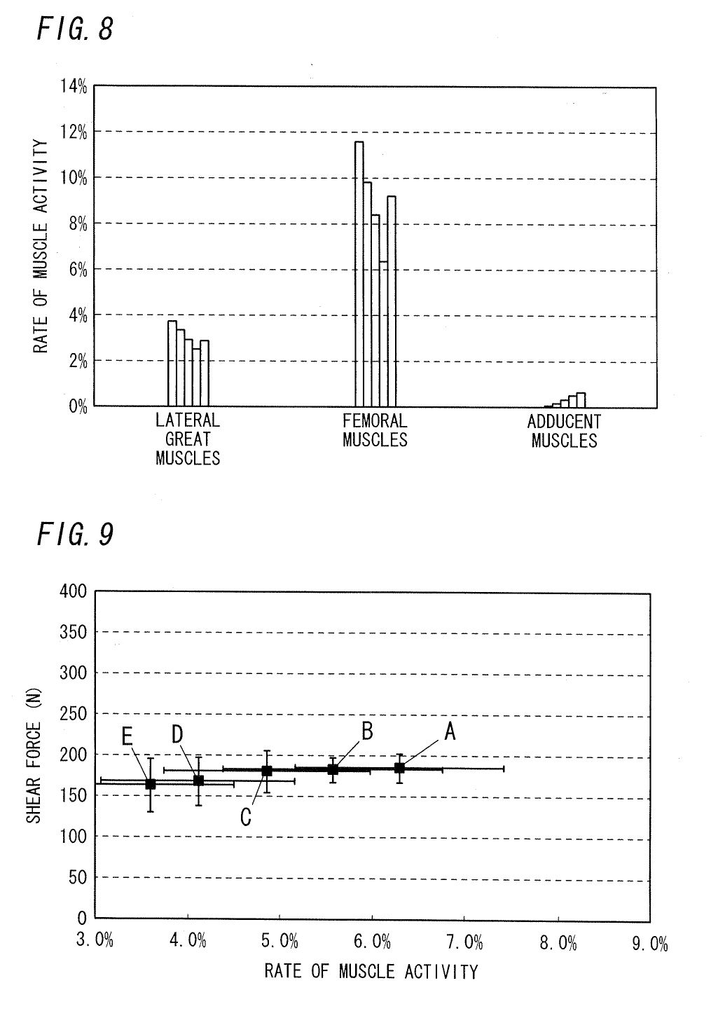

FIG. 8 shows the rate of change of muscle activity regarding vastus lateralis muscles, femoral muscles and adductor muscles (=(exercise muscle force/maximum force)×100%) when the distance in the right and left direction between right and left ankle joints is changed. FIG. 8 shows each rate of muscle activity per muscles when the distance in the right and left direction between ankle joints is changed in five stages (200 mm, 250 mm, 300 mm, 350 mm and 400 mm). Five bar charts per muscles mean that the distance between ankle joints becomes wider from left to right. In the graphical example, the standard value of the distance between right and left ankle joints is 300 mm.

From FIG. 8, it is understood that there is a increasing trend in muscles of abduction of legs (vastus lateralis muscles) and muscles of buttocks (femoral muscles) as the distance between ankle joints becomes narrower, while there is a increasing trend in muscles of adduction of legs (adductor magnus muscles) as the distance between ankle joints becomes wider (in a part is an adverse change).

FIG. 9 shows the relationship between muscle activity rates and shear force acting on knee joints when the distance between right and left ankle joints is changed. In FIG. 9, “A”-“E” show 200 mm, 250 mm, 300 mm 350 mm and 400 mm as the distance between right and left ankle joints, respectively. Each center box represents an average value of distance, and each crisscross represents variance. From FIG. 9, it is understood that shear force does not much change even though the distance between right and left ankle joints is changed, while muscle activity rates become larger as distance is larger.

In the embodiment, it is preferable that the operation of the left foot base 2a and the right foot base 2b is complex operation of anteroposterior movement and lateral movement. However, it is possible to move the left foot base 2a and the right foot base 2b only in a front-back direction or a right and left direction by each arrangement direction of the rails 43. When the left foot base 2a and the right foot base 2b can be only moved in a front-back direction, the distance between right and left ankle joints is not changed. Accordingly, it is required that the distance between right and left ankle joints is previously adjusted per user. The following embodiments are each configured to enable the positions of the left foot base 2a and the right foot base 2b to be adjusted so that the distance between right and left ankle joints can be adjusted.

### Second Embodiment

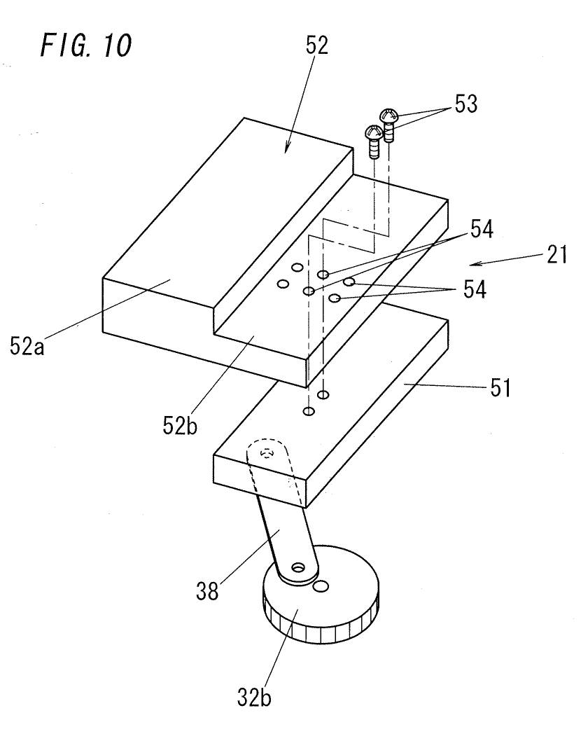

In the present embodiment, as shown in FIG. 10, a footrest plate 21 in at least one of the left foot base 2a and the right foot base 2b (which is just the left foot base 2a in the diagram but may be applied to both of them) is formed of a bedplate 51 and a footrest plate 52. In the configuration, the bedplate 51 is coupled with one end of a crank rod 38, and the footrest plate 52 is detachably mounted on the bedplate 51. The footrest plate 52 is detachably coupled to the bedplate 51. This coupling mode may be voluntary, but in the present embodiment, the bedplate 51 and the footrest plate 52 are fixed by fixation screws 53 which penetrate through the footrest plate 52 to be threaded into the bedplate 51.

Through-holes 54 in columns, which fixation screws 53 can be inserted into, are arranged in a right and left direction of the footrest plate 52. Therefore, by selecting through-holes 54 into which fixation screws 53 are inserted, it is possible to adjust the position in right, and left direction of the footrest plate 52 with respect to the bedplate 51. The footrest plate 52 is integrally formed with a step piece 52a on which a user's foot can be rested, and a fixed piece 52b which have the through-holes 54 and are fixed on the bedplate 51. A recess is formed on the top face of the fixed piece 52b and set lower than the top face of the step piece 52a. It is desirable that, in use, a cover is attached on the top face of the step piece 52a by using the recess so that the top face of the step piece 52a is not exposed.

The construction in the present embodiment can be used in place of at least one of the left foot base 2a and the right foot base 2b in the first embodiment, and it is possible to adjust the installation position of the footrest plate 52 to the bedplate 51. Therefore, the distance between right and left ankle joints in use can be adjusted in accordance with a user's body type or a region of muscles to be strengthened. The other construction and operation are the same as those of the first embodiment.

### Third Embodiment

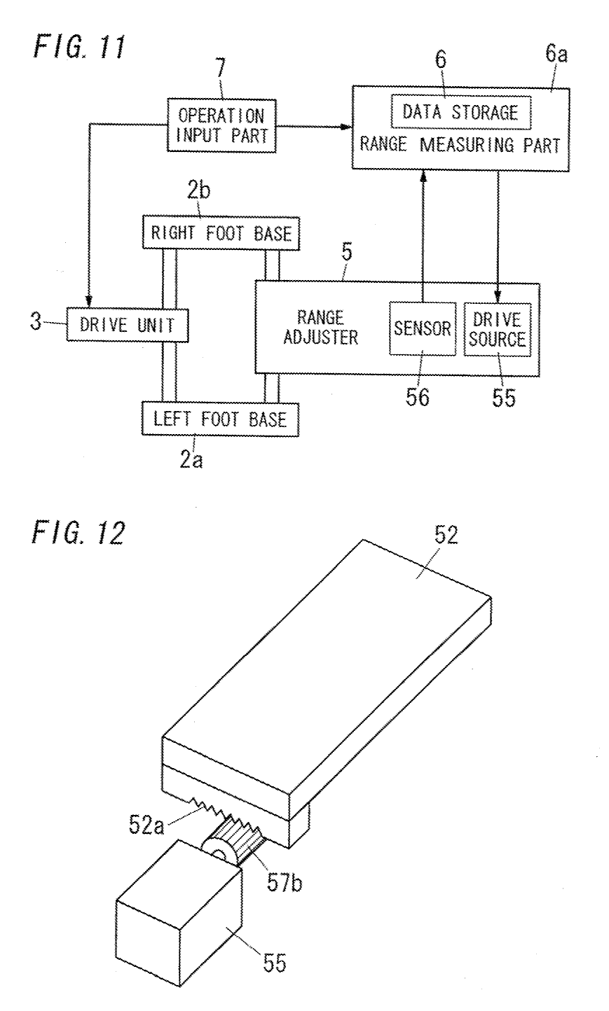

In the second embodiment, at least one position of the left foot base 2a and the right foot base 2b can be adjusted, but the position of the footrest plate 52 to the bedplate 51 is adjusted by hand working. In the present embodiment, as shown in FIG. 11, a range adjuster 5 having a drive source 55 such as a motor is used. Thereby, it is possible to adjust at least one position of the left foot base 2a and the right foot base 2b without hand working. Though only one position of the left foot base 2a and the right foot base 2b may be adjusted, in the present embodiment, both positions are adjusted at the same time.

The drive source 55 in the range adjuster 5 adjusts the distance of the left foot base 2a and the right foot base 2b based on information entered with an operation input part 7 having switches such as push switches and a display device such as a liquid crystal display. The information entered with the operation input part 7 is an attribution by which the distance between user's right and left hip joints can be calculated, as well as a region to be strengthened by exercise. It is thought that there is a correlation between the distance between right and left hip joints and a body height of user's attributions. Accordingly the distance between right, and left hip joints is entered by basically selecting a body height range from a plurality of ranges. For example, push switches for selecting body height ranges at 10 cm intervals such as 140-150 cm, 150 cm-160 cm, . . . are provided.

Thus, the standard value of the distance between right and left ankle joints is calculated by selecting a body height range. That is, the body height range selected with the operation input, part 7 is entered in a range decision part 6 and is checked with a data storage 6a in the range decision part 6. In the data storage 6a, each body height range is related to a standard value of distance between hip joints, and if a body height range is set, a standard value of distance between hip joints is estimated. Incidentally, the distance between hip joints may much depart from the standard value owing to user's body type. Accordingly, an attribution representing a body type such as body weight or BMI as well as gender may be selected in addition to a body height to obtain a standard value from the body height, the body type and gender.

In the operation input part 7, it is also possible to select a user's region to be strengthened by exercise. The region is selected with push switches like a body height range, or a region may be cyclically selected whenever one push switch is pushed. The kinds of region are, for example, three kinds of buttocks, adductor muscles and both of them.

As described in the first embodiment, in case of buttocks, the distance between the left foot base 2a and the right foot base 2b is narrowed so as to mainly include the operation that the distance between ankle joints becomes smaller than the distance between hip joints. In case of adductor muscles, the distance between the left foot base 2a and the right foot base 2b is increased so as to mainly include the operation that the distance between ankle joints becomes larger than the distance between hip joints. In case buttocks and adductor muscles are both strengthened, an operation period (in which the drive unit 3 is driven) includes a time period in which the left foot base 2a and the right foot base 2b is narrowed, and a time period in which the distance between the left foot base 2a and the right foot base 2b is increased. In the construction that the left foot base 2a and the right foot base 2b move in the right and left direction while moving in the front-back direction like the first embodiment, the position between the left foot base 2a and the right foot base 2b is adjusted so as to make time periods in which the distance between ankle joints becomes smaller and larger than the distance between hip joints, in an operating period.

The moving ranges of the left foot base 2a and the right foot base 2b in response to the region to be strengthened (i.e., a variability range of the distance between ankle joints) are relatively decided with respect to the distance between hip joints. That is, the region to be strengthened depends on a ratio or difference between the distance between hip joints and the distance between ankle joints. In the data storage 6a, each combination of a region to be strengthened and distance between hip joints is related to a variability range of distance between ankle joints (in the embodiment, distance in the right and left, direction of the left foot base 2a and the right foot base 2b when they are situated at a standard position). Therefore, a user's attribution entered with the operation input, part 7 is checked through the data storage 6a and then the distance between the user's hip joints is obtained, in addition, if a region to be strengthened has been entered with the operation input part 7, the combination of the distance between the hip joints and the region is checked through the data storage 6a and then the distance in the right and left direction of the left foot base 2a and the right foot base 2b is obtained.

Therefore, in the range decision part 6, a command value is given with respect to a drive source 55 of the range adjuster 5, and the distance between the left foot base 2a and the right foot base 2b is adjusted in response to the command value. The range adjuster 5 is provided with a position sensor 56 for detecting the positions of the left foot base 2a and the right foot base 2b. The drive source 55 is activated by a command value from the range decision part 6, and if the position sensor 56 detects that the distance between the left foot base 2a and the right foot base 2b becomes the distance indicated by the command value, the drive source 5 is deactivated.

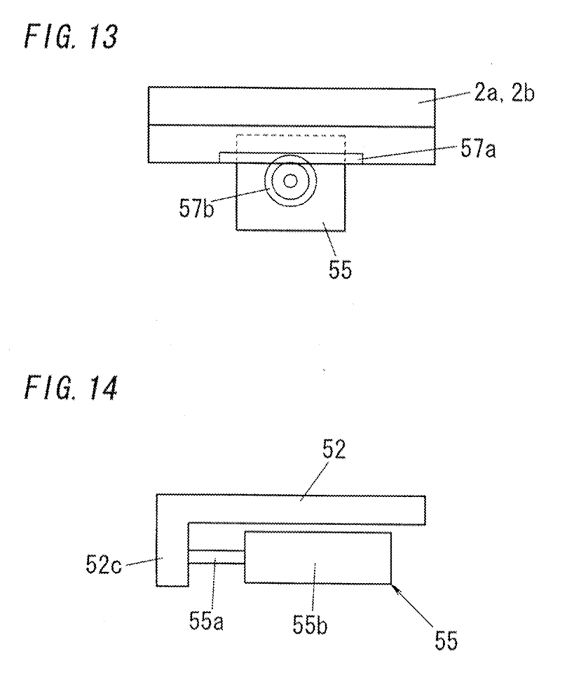

The construction shown in FIGS. 12 and 13 can be applied to the range adjuster 5. In the construction shown in FIGS. 12 and 13, each footrest plate 21 of the left foot base 2a and the right foot base 2b is formed of a bedplate 51 and a footrest plate 52 like the construction of the second embodiment. The position of the footrest plate 52 can be also adjusted with respect to the bedplate 51. However, in the graphical construction, each of the left foot base 2a and the right foot base 2b is provided with a rack 57a at its own undersurface. The motors as the drive source drive and rotate the pinions engaged with the racks 57a. The footrest plates 52 are guided by guide rails (not shown) which restrict their motion directions so as to allow movement only in the length directions of the racks 57a. Rails and a drive source 55 are mounted on each bedplate 51, and can move along with the bedplate 51 with respect to the housing 1.

FIG. 14 shows a configuration example of the range adjuster 5. Each drive source 55 is provided with a plunger 55a which can extend in a straight line, and uses an actuator which can change the extension length of the plunger 55a from the body 55b. This actuator has a magnetic circuit for a linear motor inside the body 55b, and is configured to drive the plunger 55a through the linear motor. A pushing piece 52c hung from a footrest plate 52 is coupled to the tip of the plunger 55a, and the position of the footrest plate 52 can be changed in the right and left direction of FIG. 14 in response to extension and contraction of the plunger 55a.

Each footrest plate 52 is guided by rails so as to only move in the right and left direction of FIG. 14 like the configuration shown in FIG. 12. In this case, it is difficult to secure holding force for stopping the footrest plate 52 with respect to the bedplate 51 only by actuator. Accordingly a member such as clutch or brake may be located between the bedplate 51 and the footrest plate 52 so as to make the footrest plate 52 easily move with respect to the bedplate 51 when the footrest plate 52 is moved and also to forbid the footrest plate 52 from moving with respect to the bedplate 51 when the footrest plate 52 is stopped.

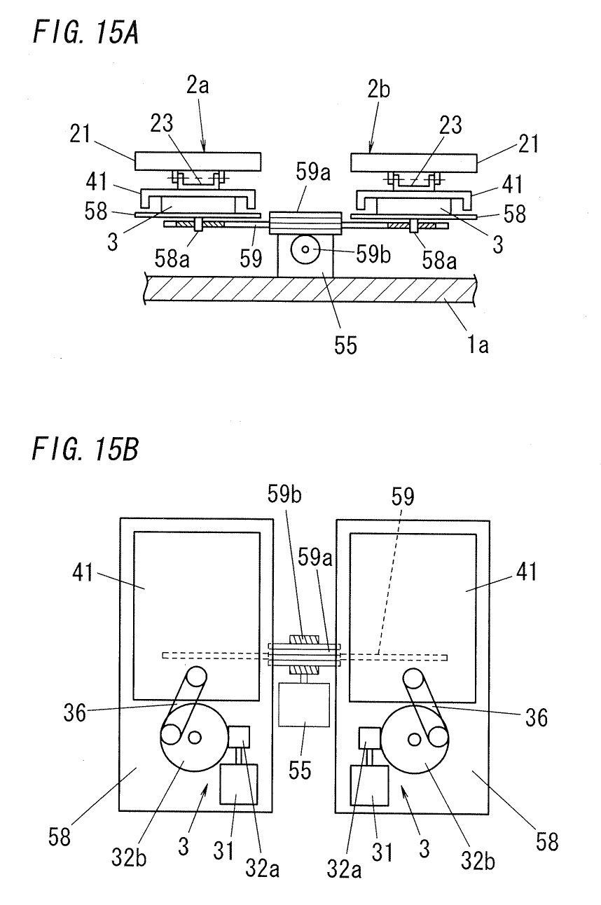

In the example, each position of the left foot base 2a and the right foot base 2b can be changed independently. However, the positions of the left foot base 2a and the right foot base 2b may be changed at the same time as a configuration example shown in FIG. 15. In this case, it is necessary to independently provide a drive unit 3 for each of the left foot base 2a and the right foot base 2b. That is, two drive sources 31 are provided, and a reciprocation driver 31 is provided for each drive sources 31. In addition, since the drive sources 31 drive the left foot base 2a and the right foot base 2b respectively, the system separation part 32 is not required.

Each reciprocation driver 33 is formed of a worm 32a coupled to the output axis 31a of a drive source 31, a worm wheel 32b engaged with the worm 32a, and a crank plate 36 of which one end is rotatably coupled to the worm wheel 32b. The other end of the crank plate 36 is turnably couple to a carriage 41 like the first embodiment.

Drive unit 3 is mounted on bases 58. Each carriage 41 can move along rails 43 (see FIGS. 1 and 2) attached to a base 58. In FIG. 15, the length directions of the rails 43 are perpendicular to the length direction of the shanks 24, but the relationship may be a non-perpendicular relationship like the first embodiment.

By the way, each moving direction of the bases 58 is restricted only in the right and left direction through rails (not shown). Screw receiving pieces 58a are each stuck out of the undersurfaces of the bases 58, and both ends of a rod screw 59 are threaded into the screw receiving pieces 58a. Parts of the rod screw 59, screwed to the screw receiving pieces 58a are each formed with screw holes which are opposite screws with each other. If the rod screw 59 is rotated, the distance in the right and left direction of the bases 58 is changed.

A worm wheel 59a is fixed at an intermediate position of the rod screw 59 in the length direction, and is engaged with a worm 59b coupled to the output axis of a motor as the drive source 55. Therefore, if the drive source 55 rotates, the rod screw 59 is rotated and the distance between the right an left bases 58 can be changed in response to a rotation direction of the drive source 55. That is, the distance between the left foot base 2a and the right foot base 2b can be changed by changing the distance between the bases 58.

In the configuration, each of the left foot base 2a and the right foot base 2b requires a drive unit 3, but right and left symmetrical property is kept because they are interlocked and move. The right, and left drive units 3 are independent, and accordingly the position relationship between the left foot base 2a and the right foot base 2b can be adjusted arbitrarily by individual control. That is, in the first embodiment, when the left foot base 2a is at the anterior end, the right foot base 2b is at the posterior end (i.e., the phase difference is 180°), but the phase difference can be set arbitrarily by adopting the configuration shown in FIG. 15. The other configuration and operation are the same as those of the first embodiment.

In the examples above, a user's attribution such as body weight or BMI is entered through the operation input part 7 in order to obtain distance between hip joints. However, the left foot base 2a and the right foot base 2b may be each provided with load sensors (not shown), and the sum of the loads detected with the load sensors may be used as user's body weight.

Although the present invention has been described with reference to certain preferred embodiments, numerous modifications and variations can be made by those skilled in the art without departing from the true spirit and scope of this invention.

1. Passive exercise equipment used in a standing position,
a left foot base and a right foot base on which left and right feet of a user in a standing position can be rested, respectively;
a drive unit for moving the left foot base and the right foot base on at least one plane surface; and
a pedestal on which the left foot base, the right foot base and the drive unit are installed,
wherein the left foot base and the right foot base are configured so that a range in which distance in a right and left direction between right and left ankle joints differs from distance between right and left hip joints is included in moving ranges of the left foot base and the right foot base.

2. The passive exercise equipment used in a standing position of claim 1, wherein the left foot base and the right foot base are configured so that a range in which the distance in the right and left direction between the right and left ankle joints is smaller than the distance between the right and left hip joints is included in the moving ranges of the left foot base and the right foot base.

3. The passive exercise equipment used in a standing position of claim 1, wherein the left foot base and the right foot base are configured so that a range in which the distance in the right and left direction between the right and left ankle joints is larger than the distance between the right and left hip joints is included in the moving ranges of the left foot base and the right foot base.

4. The passive exercise equipment used in a standing position of any one of claims 1-3, further comprising a range adjuster configured to adjust moving ranges in the right and left direction of the left foot base and the right foot base.

5. Passive exercise equipment used in a standing position,
a left foot base and a right foot base on which left and right feet of a user in a standing position can be rested, respectively;
a drive unit for moving the left foot base and the right foot base on at least one plane surface;
a pedestal on which the left foot base, the right foot base and the drive unit are installed; and
a range adjuster configured to adjust moving ranges in a right and left direction of the left foot base and the right foot base.

6. The passive exercise equipment used in a standing position of claim 4, further comprising:
an operation input part for inputting an attribution by which the distance between user's right and left hip joints can be calculated, as well as a region to be strengthened by exercise; and
a range decision part configured to estimate the distance between the right and left hip joints based on the attribution input through the operation input part and also decide the moving ranges of the left foot base and the right foot base based on the region input through the operation input part and the estimated distance between the hip joints,
wherein the range adjuster comprises a drive source and is configured to adjust the moving ranges of the left foot base and the right foot base in response to a command value,
wherein the range decision part is configured to supply the range adjuster with a decided moving range as the command value.

7. The passive exercise equipment used in a standing position of claim 5, further comprising:
an operation input part for inputting an attribution by which the distance between user's right and left hip joints can be calculated, as well as a region to be strengthened by exercise; and
a range decision part configured to estimate the distance between the right and left hip joints based on the attribution input through the operation input part and also decide the moving ranges of the left foot base and the right foot base based on the region input through the operation input part and the estimated distance between the hip joints,
wherein the range adjuster comprises a drive source and is configured to adjust the moving ranges of the left foot base and the right foot base in response to a command value,
wherein the range decision part is configured to supply the range adjuster with a decided moving range as the command value.

8. The passive exercise equipment used in a standing position of any one of claims 1, 2, 3, 5 and 7, wherein the drive unit is configured to change each position in a front-back direction of the left foot base and the right foot base.

9. The passive exercise equipment used in a standing position of claim 4, wherein the drive unit is configured to change each position in a front-back direction of the left foot base and the right foot base.

10. The passive exercise equipment used in a standing position of any one of claims 1, 2, 3, 5 and 7, wherein the drive unit is configured to change each position in a right and left direction of the left foot base and the right foot base.

11. The passive exercise equipment used in a standing position of claim 4, wherein the drive unit is configured to change each position in a right and left direction of the left foot base and the right foot base.

12. The passive exercise equipment used in a standing position of any one of claims 1, 2, 3, 5 and 7, wherein the drive unit is configured to change each position in a front-back direction and a right and left direction of the left foot base and the right foot base.

13. The passive exercise equipment used in a standing position of claim 4, wherein the drive unit is configured to change each position in a front-back direction and a right and left direction of the left foot base and the right foot base.

14. The passive exercise equipment used in a standing position of claim 6, wherein the drive unit is configured to change each position in a front-back direction of the left foot base and the right foot base.

15. The passive exercise equipment used in a standing position of claim 6, wherein the drive unit is configured to change each position in a right and left direction of the left foot base and the right foot base.

16. The passive exercise equipment used in a standing position of claim 6, wherein the drive unit is configured to change each position in a front-back direction and a right and left direction of the left foot base and the right foot base.
